(19) United States
(12) Patent Application Publication
(10) Pub. No.: US 2012/0287790 A1
(43) Pub. Date: Nov. 15, 2012

(54) Method and Apparatus

(76) Inventors: Min Huang, Beijing (CN); Wei Hua Zhou, Beijing (CN); Zhu Yan Zhao, Beijing (CN); Lei Du, Beijing (CN)

(21) Appl. No.: 13/521,323

(22) PCT Filed: Jan. 11, 2010
(86) PCT No.: PCT/CN2010/070115

§ 371 Date: Jul. 10, 2012

(51) Int. Cl. H04W 28/12

(52) U.S. Cl. 370/236

(57) ABSTRACT

A method including determining traffic adjustment information for traffic from a base station to a relay node in dependence on a quantity of data intended for each user equipment at a first quality of service level on a first radio bearer; and causing said traffic adjustment information to be sent to a network element.

### FIELD OF THE INVENTION

The present invention relates to a method and apparatus and in particular but not exclusively for a method and apparatus for determining traffic adjustment information.

### BACKGROUND

A communication system can be seen as a facility that enables communication sessions between two or more entities such as mobile communication devices and/or other stations associated with the communication system. A communication system and a compatible communication device typically operate in accordance with a given standard or specification which sets out what the various entities associated with the system are permitted to do and how that should be achieved. For example, the standard or specification may define if a communication device is provided with a circuit switched carrier service or a packet switched carrier service or both. Communication protocols and/or parameters which shall be used for the connection are also typically defined. For example, the manner how the communication device can access the communication system and how communication shall be implemented between communicating devices, the elements of the communication network and/or other communication devices is typically based on predefined communication protocols.

In a wireless communication system at least a part of the communication between at least two stations occurs over a wireless link. Examples of wireless systems include public land mobile networks (PLMN), satellite based communication systems and different wireless local networks, for example wireless local area networks (WLAN). The wireless systems can be divided into cells, and are therefore often referred to as cellular systems.

A user can access the communication system by means of an appropriate communication device. A communication device of a user is often referred to as user equipment (UE). A communication device is provided with an appropriate signal receiving and transmitting arrangement for enabling communications with other parties. Typically a communication device is used for enabling the users thereof to receive and transmit communications such as speech and data. In wireless systems a communication devices provides a transceiver station that can communicate with e.g. a base station of an access network servicing at least one cell and/or another communications device. Depending on the context, a communication device or user equipment may also be considered as being apart of a communication system. In certain applications, for example in ad-hoc networks, the communication system can be based on use of a plurality of user equipment capable of communicating with each other.

The communication may comprise, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. The user may also be provided broadcast or multicast content. Non-limiting examples of the content include downloads, television and radio programs, videos, advertisements, various alerts and other information.

3^{rd} Generation Partnership Project (3GPP) is standardizing an architecture that is known as the long-term evolution (LTE) of the Universal Mobile Telecommunications System (UMTS) radio-access technology. The aim is to achieve, inter alia, reduced latency, higher user data rates, improved system capacity and coverage, and reduced cost for the operator. A further development of the LTE is referred to herein as LTE-Advanced. The LTE-Advanced aims to provide further enhanced services by means of even higher data rates and lower latency with reduced cost. The various development stages of the 3GPP LTE specifications are referred to as releases.

Since the new spectrum bands for international mobile telecommunications (IMT) contain higher frequency bands and LTE-Advanced is aiming at a higher data rate, coverage of one Node B (base station) can be limited due to the high propagation loss and limited energy per bit. Relaying has been proposed as a possibility to enlarge the coverage. Apart from this goal of coverage extension, introducing relay concepts may also help in the provision of high-bit-rate coverage in a high shadowing environment, reducing average radio-transmission power at the User Equipment (UE). This may lead to long battery life, enhanced cell capacity and effective throughput, e.g., increasing cell-edge capacity, balancing cell load, enhancing overall performance, and reducing deployment costs of radio access networks (RAN). The relaying would be provided by entities referred to as Relay stations (RSs) or Relay Nodes (RNs).

### SUMMARY

According to one aspect of the present invention, there is provided a method comprising determining traffic adjustment information for traffic from a base station to a relay node in dependence on a quantity of data intended for each user equipment at a first quality of service level on a first radio bearer; and causing said traffic adjustment information to be sent to a network element.

According to a second aspect of the present invention, there is provide a method comprising receiving traffic adjustment information for at least one radio bearer from a relay node; and using said traffic adjustment information to control the traffic rate of said at least one radio bearer between said relay node and said base station, said at least one radio bearer having an associated quality of service and configured to carry data for a plurality of user equipment.

According to a third aspect of the present invention, there is provided an apparatus comprising means for determining traffic adjustment information for traffic from a base station to a relay node in dependence on a quantity of data intended for each user equipment at a first quality of service level on a first radio bearer; and means for causing said traffic adjustment information to be sent to a network element.

According to a fourth aspect of the present invention, there is provided an apparatus comprising means for receiving traffic adjustment information for at least one radio bearer from a relay node; and means for using said traffic adjustment information to control the traffic rate of said at least one radio bearer between said relay node and said base station, said at least one radio bearer having an associated quality of service and configured to carry data for a plurality of user equipment.

According to a fifth aspect of the present invention, there is provided a method comprising determining traffic adjustment information for traffic on a bearer from a base station to a relay node; and causing said traffic adjustment information to be sent to a network element via a tunnel associated with said bearer.

According to a sixth aspect of the present invention, there is provided a method comprising receiving in a network element, via a tunnel, traffic adjustment information for traffic from a base station to a relay node, and using said traffic adjustment information to adjust the traffic on a bearer between said base station and said relay node associated with said tunnel.

According to a seventh aspect of the present invention, there is provided an apparatus comprising means for determining traffic adjustment information for traffic on a bearer from a base station to a relay node, and means for causing said traffic adjustment information to be sent to a network element via a tunnel associated with said bearer.

According to an eighth aspect of the present invention, there is provided an apparatus comprising means for receiving in a network element, via a tunnel, traffic adjustment information for traffic from a base station to a relay node, and means for using said traffic adjustment information to adjust the traffic on a bearer between said base station and said relay node associated with said tunnel.

According to a ninth aspect of the present invention, there is provided a method comprising determining if a throughput on a relay downlink is to be changed in dependence on a throughput of said relay downlink, a throughput of an access link of said relay node and network traffic load.

According to a tenth aspect of the present invention, there is provided an apparatus comprising means for determining if a throughput on a relay downlink is to be changed in dependence on a throughput of said relay downlink, a throughput of an access link of said relay node and a network traffic load.

### BRIEF DESCRIPTION OF DRAWINGS

Some embodiments of the invention will now be described in further detail, by way of example only, with reference to the following examples and accompanying drawings, in which:

FIG. 1 shows a cell with three relay nodes:

FIG. 2 shows the interfaces between a relay node, a base station and a UE (user equipment):

FIG. 3 shows a user plane protocol stack;

FIG. 4 shows a control plane protocol stack;

FIG. 5 shows per QoS (quality of service) radio bearer mapping:

FIG. 6 shows downlink flow control procedures in accordance with an embodiment of the invention, between a base station and a relay node;

FIG. 7 shows a block diagram of an apparatus usable with some embodiments of the invention;

FIG. 8 shows a method of a further embodiment; and

FIG. 9 shows a further method embodying the invention.

### DETAILED DESCRIPTION OF SOME EMBODIMENTS

As specified in 3GPP TR 36.814 (Third Generation Partnership Project) relaying is considered as one of the potential techniques for LTE-A where a relay node is wirelessly connected to the radio access network via a donor cell. Some embodiments of the invention are described in the context of the LTE-A proposals. However, other embodiments of the invention can be used in any other scenario which for example requires or uses one or more relays.

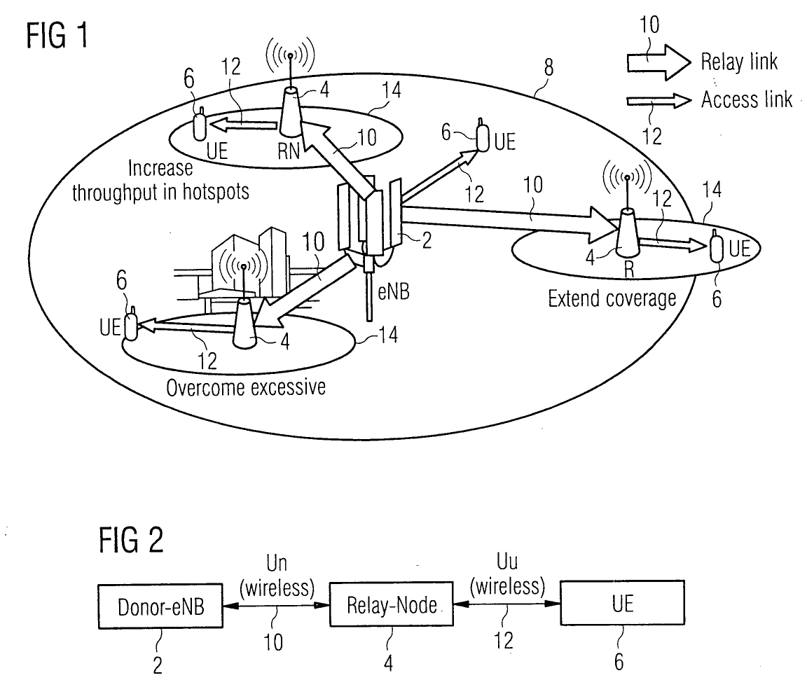

Reference is made to FIG. 1 which shows part of a LTE radio access network (RAN). An access node 2 is provided. The access node can be a base station of a cellular system, a base station of a wireless local area network (WLAN) and/or WiMax (Worldwide Interoperability for Microwave Access). In certain systems the base station is referred to as Node B, or enhanced Node B (e-NB). For example in LTE-A, the base station is referred to as e-NB. The term base station is intended to include the use of any of these access nodes or any other suitable access node. The base station 2 has a cell 8 associated therewith. In the cell, there is provided three relay nodes 4. This is by way of example only. In practice there may be more or less than three relay nodes. One of the relay nodes 4 is provided close to the edge of the cell to extend coverage. One of the relay nodes 4 is provided in a traffic hotspot and one of the relay nodes is provided at a location where there is an issue of shadowing from for example buildings. Each of the relay nodes has a coverage area 14 associated therewith. The coverage area may be smaller than the cell 8, of a similar size to the cell or larger than the cell. A relay link 10 is provided between each relay node 4 and the base station 2. The cell has user equipment 6. The user equipment is able to communicate directly with the base station 2 or with the base station 2 via a respective relay node 4 depending on the location of the user equipment 6. In particular, if the user equipment 6 is in the coverage area associated with a relay node, the user equipment may communicate with the relay. The connections between the user equipment and the relay node and the direct connections between the user equipment and the base station are referenced 12.

The UE or any other suitable communication device can be used for accessing various services and/or applications provided via a communication system. In wireless or mobile communication systems the access is provided via an access interface between mobile communication devices (UE) 6 and an appropriate wireless access system. The UE 6 can typically access wirelessly a communication system via at least one base station. The communication devices can access the communication system based on various access techniques, such as code division multiple access (CDMA), or wideband CDMA (WCDMA), the latter technique being used by communication systems based on the third Generation Partnership Project (3GPP) specifications. Other examples include time division multiple access (TDMA), frequency division multiple access (FDMA), space division multiple access (SDMA) and so on. In a wireless system a network entity such as a base station provides an access node for communication devices.

Each UE may have one or more radio channels open at the same time and may receive signals from more than one base station and/or other communication device.

A “type 1” RN has been proposed, which is an inband relaying node having a separate physical cell ID (identity), support of HARQ (Hybrid automatic repeat request) feedback and backward compatibility to Release 8 (Rel 8) UEs. Release 8 is one of the versions of LTE.

In the RAN2 #65bis meeting (this is part of 3GPP), RAN 2 agreed with the definition for the nodes and the interfaces as shown in FIG. 2. The wireless interface 12 between UE 6 and RN is named the Uu interface. For those embodiments where backward compatibility is desirable for example where compliance with a particular version of 3GPP standards TR 36.913 and TR36.321 is provided, the Uu interface would be consistent with the Release 8 interface as defined in LTE.

The wireless interface 10 between the relay node 4 and the donor e-NB 2 is the Un interface. The link is considered as backhaul link.

Some embodiments of the invention relate to downlink flow control factors in accordance with per-QoS radio bearers over the backhaul link from donor eNB to relay node. It should be appreciated that whilst embodiments of the invention have been described as controlling downlink flow in the Un interface, alternative embodiments of the invention may additionally or alternatively be used to control the downlink flow in the Uu interface.

In relay systems, downlink flow control in backhaul link was discussed in meeting RAN2#66bis and a mechanism was suggested as being required in the DL-Un interface. In RAN2#67bis, four types of flow control methods are listed: Per Uu radio bearer (RB) flow control, Per UE flow control, Per Un RB (radio bearer) flow control, and Per relay node flow control (see R2-095528, “DL Flow Control in Un interface”, LG Electronic Inc., 3GPP TSG-RAN2 Meeting #67bis, Miyazaki, Japan, Oct. 12-Oct. 16, 2009).

Different flow control methods may be used with different relay system architectures. Currently in RAN2/3 discussions, a total of four relay system architecture have been proposed: see for example R2-095336, “TP to internal TR on relay architecture options”, Ericsson, ST-Ericsson, 3GPP TSG-RAN WG2 #67, Shenzhen, China, 24th-28 Aug. 2009.

The four relay architectures can be summarised as follows.

### Alternative 1: Full-L3 Relay, Transparent for the DeNB;

The U (User)-plane packets of a UE served by the RN are delivered via the Relay's P/S (packet switched)-GW. The UE's P/S-GW maps the incoming IP packets to the GTP tunnels corresponding to the EPS (evolved packet system) bearer of the UE and sends the tunnelled packets to the IP address of the RN. The tunnelled packets are routed to the RN via the Relay's P/S-GW, as if they were packets destined to the RN as a UE.

### Alternative 2: Proxy S1/X2;

There is a GTP tunnel per UE bearer, spanning from the SGW (signalling gateway)/PGW (packet data network gateway) of the UE to the donor eNB, which is switched to another GTP tunnel at the DeNB, going from the DeNB to the RN (one-to-one mapping).

### Alternative 3: RN Bearers Terminate in DeNB;

The baseline solution is enhanced by integrating the SGW/PGW functionality for the RN into the DeNB. The routing path is optimized as packets do not have to traverse via a second PGW/SGW but otherwise the same functionality and packet handling apply as in case of Alternative 1.

### Alt 4: S1 U-Plane Terminated in DeNB.

The U-plane of the S1 interface is terminated at the DeNB. The PGW/SGW serving the UE maps the incoming IP packets to the GTP tunnels corresponding to the EPS bearer of the UE and sends the tunnelled packets to the IP address of the DeNB.

The first and third alternatives make the donor-eNB (DeNB) transparent to UE-gateway (UE-GW) and may have a minimal impact on existing eNB operation. In contrast, the second and fourth alternatives fit the DeNB to support the proxy of IP (Internet Protocol) packets to a relay node (RN) or to transit the data with a layer-2 format. These latter two alternatives may require the operation of existing eNBs to change

It should be appreciated that embodiments of the invention are not limited to the four relay systems mentioned above and may be used with any other alternative relay architecture.

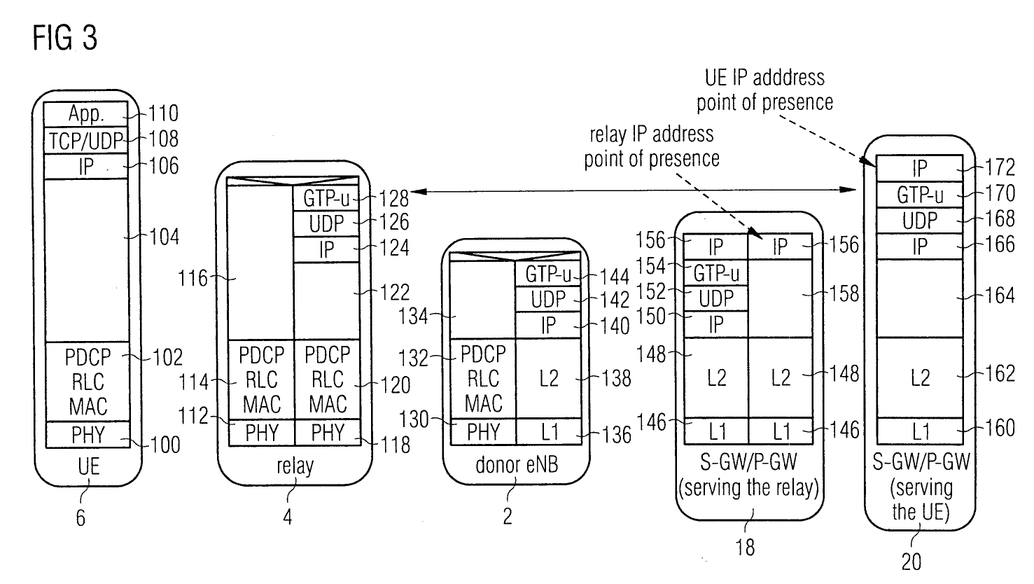

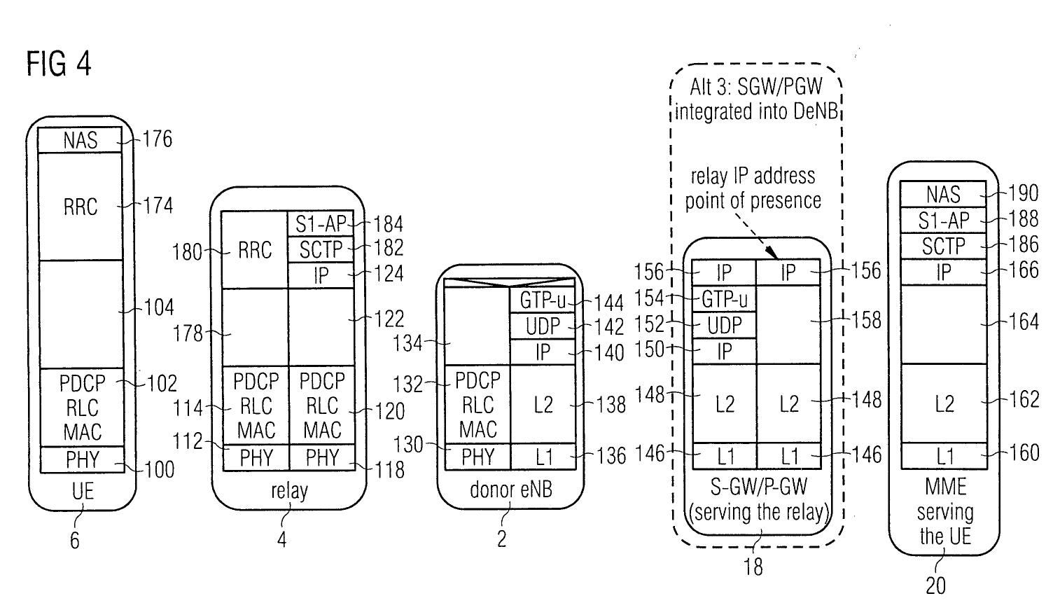

Some embodiments of the invention have the user-plane and control-plane protocol as shown in FIGS. 3 and 4 respectively. For example, the arrangement of FIGS. 3 and 4 may be used with the first and third relay architecture alternatives mentioned previously.

Referring to FIG. 3 which shows the user plane, the user equipment comprises a first physical PHY layer 100. The user equipment has a second layer 102 which comprises a PDCP (packet data convergence protocol), RLC (radio link control) and MAC (medium access control) layer. A third layer 104 is provided. The fourth layer 106 is the IP layer. The fifth layer is the TCP/UDP (Transmission Control Protocol/User Datagram Protocol) layer. The final layer is the application layer 110.

The relay 4 has a protocol stack towards the user equipment and a protocol stack towards the donor eNB 2. The protocol stack towards the user equipment has a first physical PHY layer 112, a PDCP/RLC/MAC layer 114 and a third layer 116. The protocol stack towards the donor eNB has a PHY layer 118, a PDCP/RLC/MAC layer 120, a third layer 122 and a fourth IP layer 124. A fifth UDP layer 120 is provided with the GTP-u layer 128 on top of the UDP layer.

The donor eNB has a protocol stack towards the relay and a protocol stack towards the gateways. The protocol stack towards the relay has a first PHI layer 130, a second PDCP/RLC/MAC layer 132 and a third layer 134. The protocol stack towards the gateways comprises a first L1 layer 136, a second L2 layer 138, a third IP layer 140, a fourth UDP layer 142 and a fifth GTP-U layer 144.

The Gateway 18 serving the relay has two protocol stacks, one facing the donor eNB and one facing the gateway 20 serving the UE. The protocol stack facing the donor eNB has a first L1 layer 146, a second L2 layer 148, a third IP layer 150, a fourth UDP layer 152, a fifth GTP-u layer 154 and a final IP layer 156. The protocol stack facing the gateway 20 serving the UE comprises a first L1 layer 146, a second L2 layer 148, a third layer 158 and a fourth IP layer 156. This provides the relay IP address point of presence.

The gateway 20 serving the UE comprises a first L1 layer 160, a second L2 layer 162, a third layer 164, a fourth IP layer 166, a fifth UDP layer 168, a sixth GTP-u layer 170 and finally IP layer 172. This provides the UE IP address point of presence.

With reference to FIG. 4 which shows the control plane protocol, only those layers which are different from FIG. 3 will be described. As far as the user equipment is concerned, the first three layers are as shown in FIG. 3. The fourth layer 174 is the RRC layer (Radio Resource Control) and the fifth layer is the NAS (Non Access Stratum) layer.

For the relay node 4, the first and second layers 112 and 114 of the protocol stack facing the user equipment are the same as in relation to FIG. 3. There is a third layer 178 and the fourth layer 180 is the RRC layer. For the protocol stack of the relay node facing the donor eNB, the first four layers are as in FIG. 3. The fifth layer 182 is a SCTP (Stream Control Transport Protocol) layer whilst the final layer 184 is a S1 application protocol layer.

The donor eNB has the same protocol structure as shown in FIG. 3.

As regards the gateway 18 serving the relay node, this again has the same structure as shown in FIG. 3.

Finally, the gateway 20 serving the UE has the same first four layers as the corresponding element shown in FIG. 3. The fifth layer 186 is a STP layer. The sixth layer 188 is a S1-AP layer whilst the final layer is a NAS layer 190.

For the quality of the service flow control, the MAC layer is used. For the per/UE bearer flow control, the GTP-U layer is used. This will be explained in more detail later.

It should be appreciated that in one embodiment, for example the third alternative relay structure, the gateway 18 serving the relay may be incorporated into the eNB.

In some embodiments the DeNB 2 serves as a transparent tunnel between the UE-GW 20 and the UE. That means that the UE 6 and DeNB 2 cannot see each other, and neither can the UE-GW 20 see the DeNB 2. The DeNB 2 will see the relay node 4 as a normal UE, and see the RN-GW 18 as a normal UE-GW.

Since DeNB cannot see the relay node-attached UE, the radio bearers between relay node and DeNB (called the relay node radio bearers) are established between the DeNB and the macro UE, i.e., in accordance with different QoS levels (called per-QoS) instead of in accordance with different UEs.

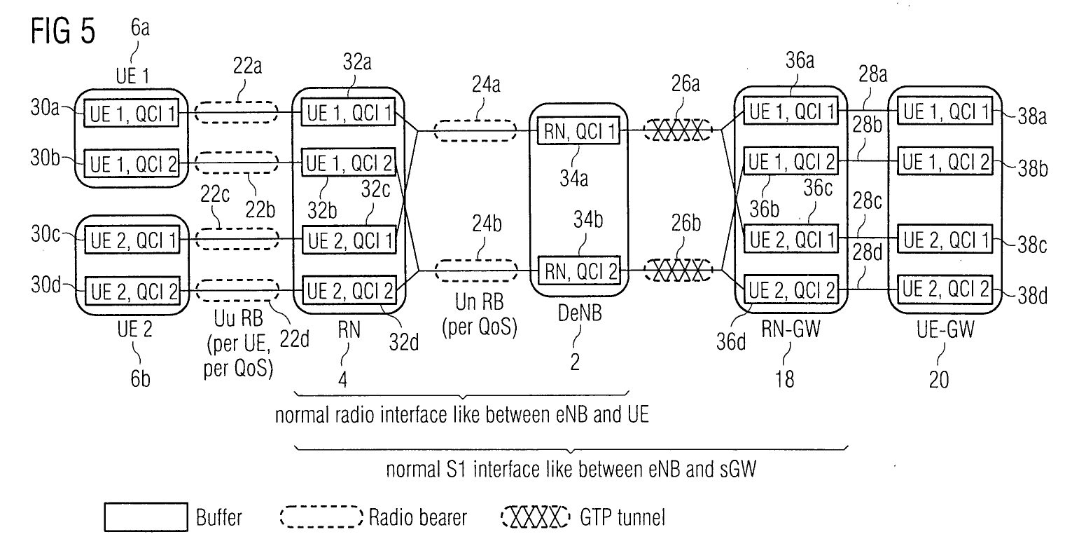

Reference is now made to FIG. 5. It is assumed that two UEs 6a and 6b are attached to the relay node 4. Each UE has two Uu radio bearers 22a and b, and 22 c and d, respectively. Each radio bearer is associated with a respective buffer 30a to d. Buffers 30a and b are in the first UE 6a whilst buffers 30c and d are in the second UE 6b. Each UE has two radio bearers with different QoS levels, indexed by QoS class index (QCI) 1 and 2.

It should be appreciated that any alternative way of defining different QoS levels can be used. The relay node 4 is provided with four buffers 32a to d, each of which is respectively associated with one of the radio bearers 22a to d from the relay node to the respective UEs 6a and b.

The Un interface from the DeNB 2 comprises two radio bearers 24a and 24b. The packets which have the QCI of 1 are associated with the first radio bearer 24a whilst the packets which have the QCI of 2 are associated with the second radio bearer 24b. This means that packets for the first UE and the second UE will be carried on both of the two radio bearers 24a and 24b in dependence on the QCI of the packets and not on the destination UE. The DeNB has a first buffer 34a associated with the first radio bearer 24a and a second buffer 34b associated with the second radio bearer.

The relay node GW 18 is connected to the DeNB 2 via first and second GTP(GPRS (General Packet Radio Service) Tunnelling protocol) tunnels 26a and 26b. A pair of GTP-U entities are setup between RN-GW and DeNB, running the GTP-U protocol. This is shown in FIG. 3.

The first tunnel 26a is associated with the QCI of 1 whilst the second tunnel is associated with a QCI of 2. The relay node GW 18 comprises four buffers 36a to d. The first buffer 36a is associated with the first UE and is for the packets with a QCI of 1. The second buffer 36b is associated with the first UE and is for the packets with a QCI of 2. The third buffer 36c is associated with the second UE and is for the packets with a QCI of 1. The fourth buffer 36d is associated with the second UE and is for the packets with a QCI of 2. The first and third buffers 36a and c map to the first tunnel 26a and the second and fourth buffers 36b and d map to the second tunnel 26b.

The UE-GW 20 has four buffers 38a to d which correspond to the four buffers 36a to d of the relay node GW. There is a one to one mapping between the buffers so the first buffer 38a of the UE-GW 20 is connected to the first buffer 36a of the relay node GW.

Once the RN-GW 18 forwards data to the DeNB 2 via the GTP tunnels 26a and 26b, the DeNB 2 can only recognize its QoS level (here represented by QCI value), rather than which UE this data belongs to. That means the DeNB cannot distinguish the different UEs' data, or adjust the traffic rate dedicated for one UE.

Then, via the per-QoS Un-radio bearers 24a and b the DeNB 2 forwards the data to the relay node 4. The contents of each Un radio bearer might belong to more than one UE.

Finally, the relay node 4 can read out the UE's IP packets by decoding the piggybacked signalling above the UE's IP layer, and send them to UEs 6a and b via individual Uu-radio bearers 22a to d respectively.

If the relay node finds that the radio channel of a UE (called the injured UE) degrades and hence congestion is caused, i.e., the Uu capacity for this UE decreases and the buffers which store the downlink data for the injured UE at the relay node are ready to overflow, the associated Un traffic rates should be reduced. If the Un traffic rates are not reduced, the Un resource which is used to transmit the overfilled data is wasted. This action of adjusting Un traffic is called downlink flow control. Some embodiments of the invention may reduce the Un traffic associated with the injured UE.

Current proposals for per Un radio bearer flow control and per UE bearer flow control have problems. On one hand, since the Un radio bearers are set up on a per-QoS basis, the per-UE flow control may not be implemented in the Un interface simply. On the other hand, per-UE bearer flow control specifically for the injured UE, which aims at the GTP tunnel between relay node and UE-GW rather than Un connection can be used.

Some embodiments of the invention may be used to control the downlink flow of a UE in relay systems.

One method for providing downlink flow control is to limit the downlink traffic in network side, so as to adjust the traffic in GW. The network side flow control may have a long delay, and may not suit an environment where there is a fast changing radio channel. This may be the case where the radio channel is changed quickly in the Uu interface due to a UE's mobility.

Another method is to perform downlink flow control at the DeNB. Since the downlink traffic is not generated by the DeNB itself, if the DeNB reduces the traffic of the relay link (Un interface), this will cause the superfluous traffic to be buffered in the DeNB. The DeNB may be responsible for the downlink packets' trans-mission priority and for which packets are to be discarded. Otherwise, the downlink traffic will be sent to the relay node and the superfluous packets will be buffered in the relay node. In this case, the relay node will perform the downlink flow control for the UE. The relay node will make the decision as to the downlink packets' transmission priority and which of the packets are to be discarded.

Furthermore, when the DeNB perform the downlink flow control, the flow control can be divided between per relay based flow control and per UE based flow control. Per relay based flow control means that DeNB will control the relay link throughput (that is the capacity of Un interface) based on the relay node and not distinguish the traffic of the different UEs of the relay node. Per UE based flow control means that DeNB will control the relay link throughput (capacity of Un interface) based on the traffic of each UE attached to the relay node

In the above mentioned alternatives 1 and 3 of the relay architecture, the DeNB only supports per relay node based flow control, since the DeNB has no per UE based traffic information. With the proposed alternatives 2 and 4 of the relay architecture, the DeNB can support both per relay node based flow control and per UE based flow control. When the DeNB performs per relay based flow control, all the UEs attached to the relay node (even those UE which have a good access link) will be affected. Per UE based flow control may be better for flow match but on the other hand, per relay node based flow control has a relatively low complexity.

As described above, when the downlink flow control is carried out by DeNB, the DeNB decides the capacity of the relay link (Un interface) according to relay node's access link (Uu interface) capacity. Since the source traffic generation is not controlled, the superfluous packet may be either buffered in the DeNB or buffered in the relay node according to the different downlink flow control schemes embodying the invention.

As the DeNB may have a bigger buffer than the relay node, more superfluous packets can be buffered in the DeNB. However in alternative embodiments the relay nodes may be provided with relatively large buffers.

If the DL packet is to be discarded, this will reduce unnecessary transmission in the relay link. Unlike backhaul transmission using fibers or microwaves, the radio resource of the relay link of the relay node is shared with the UEs directly connected with the DeNB and other relay nodes connected with the DeNB. The radio resource is valuable especially when the load in the DeNB is heavy

For the first and third relay architectures, the DeNB may not perform the per UE downlink flow control since the UE bearer is transparently delivered over the DeNB. As mentioned above, limiting the DL traffic in relay link will affect all the UEs connected with the relay node. When the load of the DeNB is light, if the DL traffic is buffered in the DeNB, the transmission may be blocked in the relay link when the load of the DeNB becomes high or the relay channel deteriorates.

When the load of the DeNB is light, the method that transmits the superfluous packet to relay node directly will reduce the risk of transmission blocking due to the DeNB load becoming high and the relay channel becoming bad.

Where the packets are buffered in the relay node, the relay node can perform per UE based downlink flow control. However if the DL packet is ultimately discarded, transmitting the superfluous packet to relay node will increase unnecessary transmission in the relay link and increase the system load. The buffered data length may be limited by the memory size of the relay node

DeNB based downlink flow control may decide the capacity of the relay link, and therefore decide where the superfluous packet will be buffered. Each superfluous packet buffer embodiment has its own advantages depending on different network load, relay link conditions, relay node buffers, and relay node's access radio link conditions.

Current proposals for flow control relate to the per Uu radio bearer flow control. The relay node informs the DeNB via a feedback message that the radio bearer of a UE is congested. The DeNB would reduce the traffic of radio bearer of UE in the Un radio bearer. However, if relay system architecture alternative 1 or 3 used the “per Uu radio bearer” method may not be appropriate since the UE bearer is transparent to DeNB.

Current proposals also include the per Un radio bearer approach. The Un radio bearer link instead of the Uu radio bearer link is congested, and hence only the traffic of the congested Un radio bearer link is requested to be reduced. For a per QoS bearer mapping, it is possible that the relay node manages the DL (downlink) buffers per QoS of radio bearers. However, in reality, since relay nodes can distinguish the packets of different UE, its DL buffers are normally managed per UE per QoS. It is possible that the channel condition of in Uu gets worse and the congestion happens in Uu radio bearers.

In some embodiments of the invention, the problem of Uu radio bearer congestion in relay architectures 1 and 3 may be addressed. Alternative embodiments may be used with architectures 2 and 4 as well as other relay architectures.

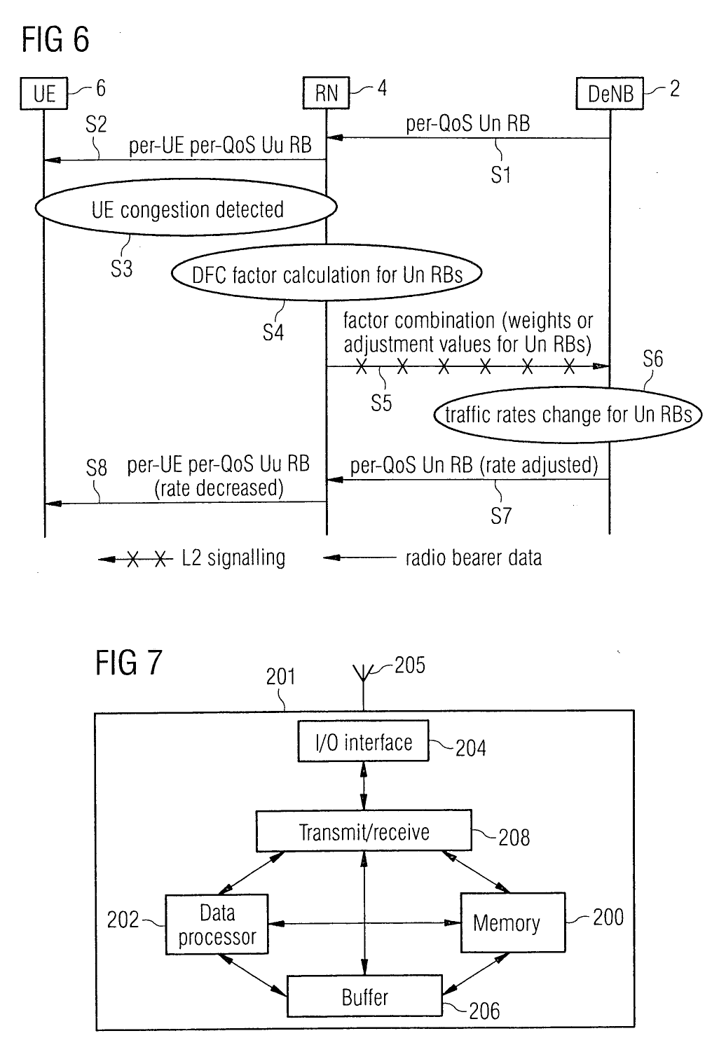

In one embodiment of the invention, there is provided a per-QoS based flow control method, called “per-QoS based method”, which provides the operation between DeNB and relay node in the Un interface. This is shown in FIG. 6. In for example relay architecture alternatives 1 and 3 with per-QoS radio bearer in Un, the DeNB is unable to distinguish each UE's content from each On radio bearer. In case congestion for an injured UE in Uu happens, a method which functions between the DeNB and the relay node to implement a relative fast downlink flow control for the injured UE, and at the same time, to minimize the impact on non-injured UEs, may be provided.

The relay node calculates a group of weights or adjustment steps, each of which is applied for one per-QoS Un radio bearer, in accordance with the proportion of data for each UE into Un radio bearers. The relay node indicates these values to the DeNB, and the DeNB applies these values to control the traffic rates of Un radio bearers.

In step S1 per QoS radio bearer(s) are provided from the DeNB 2 to the RN 4.

In step S2, a per UE, per QoS radio bearer(s) are provided from the RN 4 to the UE 6.

In one embodiment, with the per-QoS radio bearer in the Un interface, the DeNB is unable to distinguish the content of each UE from each Un radio bearer. In case congestion for an injured UE in Uu is detected as shown in step S3, in one embodiment a method is implemented between the DeNB and the relay node which may provide a fast downlink flow control for the injured UE, and at the same time, may minimize the impact on non-injured UEs

Since the DeNB can adjust the traffic rate of each individual per-QoS Un radio bearer, the DeNB can approach the flow control of one UE by weighing or adjusting the traffic rates of these per-QoS Un radio bearers. Thus in step S4, the weights or adjustment values may be derived from the feedback information at the relay node. Since the relay node is aware of the load percentages destined for each UE in each QoS level, the relay node can calculate a proper weight or adjustment value for each Un per-QoS radio bearer, by which the flow control towards the injured UE is implemented and the impact on the traffic rates of non-injured UEs may be minimized. One factor, which defines how to weigh or adjust the traffic rate, is introduced for each Un radio bearer. Multiple factors may be grouped as a “factor combination”. These factors may be given by the RN in accordance with the load percentages destined for each UE in each QoS level. Since the relay node distributes the “per-QoS Un radio bearers” to “per-UE per-QoS Uu radio bearers”, the relay node is able to know how many packets are destined to one UE over one Un radio bearer. Therefore, the load percentages destined for each UE in each QoS level is available at relay node.

This factor combination is delivered from the relay node to DeNB via Un interface, in step S5. Further, this delivery can be performed in MAC layer, for example. To do so, a Downlink Flow Control (DFC) MAC control element (CE) may be provided in the Un uplink. The delivery of these flow control MAC CE can be periodically controlled, triggered by an event, or padded in a MAC PDU. This is discussed in more detail later. Alternative embodiments may use any other suitable mechanism for delivering the required information to the DeNB.

In alternative embodiment, this delivery may be via the RRC layer, or a U-plane layer (for example the RLC (radio link control) layer or the PDCP (Packet Data Convergence Protocol) layer).

In step S6, the DeNB uses the received factor combination to control the flow of per-QoS radio bearers in Un. The traffic rates are changed for the Un radio bearers.

These procedures happen between the relay node and the DeNB via the radio Un interface. They can be typically performed in MAC layer. This may provide low latency, low signalling overhead, no impact on the high-layer operations and/or no impact on RN-GW/UE-GW/MME (mobility management entity).

The QoS based method may be especially suitable for fast downlink flow control in the Un interface. In the following three example forms of Downlink Flow Control (DFC) MAC CE (medium access control control element) are given:

Periodic DFC MAC CE: a periodic timer is introduced and on expiry of the timer, the downlink flow control factors are delivered from relay node to DeNB. Alternatively or additionally, the timer may be set to trigger the delivery of the downlink flow control factors when the timer reaches a predetermined count.

Regular DFC MAC CE: triggering events are defined e.g., when buffer overfilling is about to occur or has already occurred.

Padded DFC MAC CE: if there is spare space in a MAC PDU (packet data unit) and the DFC MAC CE size is no larger than the size of the spare space, the DFC information is padded into MAC PDU.

It should be appreciated that the DFC may be provided by any other suitable method. By way of example, the DFC could be provided via the RRC layer using radio bearer modification.

In the following two examples of formats for the DFC MAC CE are given:

Option 1: n=2 bits are used to denote the factor of one Un radio bearer (QoS level). All the factors are delivered. The number of factors equals the number of QoS levels in Un.

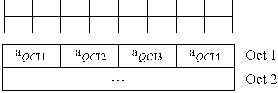

The subscript “QCI1” indicates that “a” is the value for QCI1 Un RB and so on.

Option 2: n (e.g., =4) bits are used to denote the factor of one Un radio bearer (QoS level). m (e.g., =4) bits are used to denote the QCI or any Un radio bearer index, e.g. LCID (Logical Channel ID). l (e.g., =4) radio bearers are adjusted once.

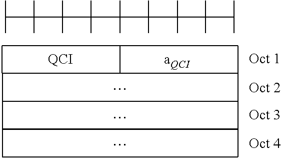

In per-QoS based flow control, the UE-to-Un radio bearer percentage mapping is known by the relay node, denoted as T, which is a n_{UE}×n_{UnRB} matrix, where n_{UE} denotes the number of UEs, and n_{UnRB} denotes the number of Un radio bearers.

The traffic rates of the Un radio bearers is denoted by s, which is a n_{UnRB}×1 vector. sᵢ represents the traffic rate of Un radio bearer i, i=1, . . . , n_{UnRB}.

The traffic rates of the UEs is denoted u, which is a n_{UE}×1 vector. uⱼ represents the traffic rate of UE j, j=1, . . . , n_{uE}.

In the balanced scenario, u=Ts.

In the case of potential congestion for some user service flows {j₁, . . . , j_{K}}, the inflow of service data should be temporarily reduced to desired values {ũⱼ_{₁}, . . . , ũⱼ_{_{K}}}, i.e., a new UEs' traffic rate vector ũ should be given. In order to keep the balance, the Un radio bearers' traffic rate should also be modified accordingly by calculating the Moore-Penrose Inverse \tilde{s}=(T^{H}T)⁻¹T^{H}ũ, and the weights αᵢ=\tilde{s}ᵢ/sᵢ, i=1, . . . , n_{UnRB} should be provided to the DeNB. Whether Moore-Penrose Inverse is valid may depend on the rank of T. If T is rank-less, the absolute object ũ cannot be obtained, and some approximate approaches may be used. If a priority strategy is applied for UEs' traffic rate, a diagonal priority matrix G may be added into the formula: \tilde{s}=(T^{H}T)⁻¹T^{H}Gũ.

One example is provided here with two UEs, whose Uu radio bearers have two QoS levels. The table below is used to denote the percentage of Un radio bearers distributed to Uu radio bearer.

Un radio bearer

| | | QCI1, Weighted | QCI2, Weighted |
|---|---|---|---|
| | | by α₁ | by α₂ |
| Uu | UE1 | p₁₁ | p₁₂ |
| radio | UE2 | p₂₁ | p₂₂ |
| bearer | | | |

p_{i,j}: is the percentage of UE i's QCI j Uu radio bearer traffic over the total traffic from DeNB to relay node, satisfying 0≦p_{i,j}≦1, and

$${\sum }_{i = 1}^{2} {\sum }_{j = 1}^{2} {p}_{i , j} = 1.$$

The sum traffic percentage for UE i is

$${\sum }_{j = 1}^{2} {p}_{i , j} .$$

Here it is assumed that the total traffic rate from the DeNB to the relay node remains the same and normalized as 1, then p_{i,j} equals the traffic rate for UE i's QCI j Uu radio bearer. The DeNB can only see the total traffic rate for each QoS level: p_{1,1}+p_{2,1}, p_{1,2}+p_{2,2}.

αⱼ: is the target adjustment weight for QCI j Un radio bearer traffic, satisfying αⱼ≧0. In this example, {α₁,α₂} are calculated by relay node, and then quantified and delivered to the DeNB.

Assume the initial percentage is p_{i,j}⁽⁰⁾, then the adjusted percentage is \tilde{p}_{i,j}=αⱼp_{i,j}⁽⁰⁾; UE 1 is “injured” and the requirement of its flow control is to halve its total traffic rate in the Uu interface including two QoS levels. If the total traffic from the DeNB to the relay node remains, the requirement becomes \tilde{p}_{1,1}+\tilde{p}_{1,2}=α₁p_{1,1}⁽⁰⁾+α₂p_{1,2}⁽⁰⁾→(p_{1,1}⁽⁰⁾+p_{1,2}⁽⁰⁾)/2.

Then, at the same time, if the traffic for UE 2 is maintained, the optimization is \tilde{p}_{2,1}+\tilde{p}_{2,2}=α₁p_{2,1}⁽⁰⁾+α₂p_{2,2}⁽⁰⁾→p_{2,1}⁽⁰⁾+p_{2,2}⁽⁰⁾; if the traffic for UE 2 is maximised, the optimization becomes

$${arg}_{{α}_{1} , {α}_{2}} max ( {\tilde{p}}_{2 , 1} + {\tilde{p}}_{2 , 2} ) ,$$

subjected to (\tilde{p}_{2,1}+\tilde{p}_{2,2})≦1−(\tilde{p}_{1,1}+\tilde{p}_{1,2}).

In the following example the UEs have different QoS levels

$$[ \begin{matrix}{p}_{1 , 1}^{( 0 )} & {p}_{1 , 2}^{( 0 )} \\ {p}_{2 , 1}^{( 0 )} & {p}_{2 , 2}^{( 0 )}\end{matrix} ] = [ \begin{matrix}0.4 & 0 \\ 0 & 0.6\end{matrix} ]$$

In this case, the calculation result when traffic of UE2 is maintained or maximized is α₁=0.5, α₂=1 or 1.33, respectively. The following example is without QoS priorities

$$[ \begin{matrix}{p}_{1 , 1}^{( 0 )} & {p}_{1 , 2}^{( 0 )} \\ {p}_{2 , 1}^{( 0 )} & {p}_{2 , 2}^{( 0 )}\end{matrix} ] = [ \begin{matrix}0.3 & 0.1 \\ 0.1 & 0.5\end{matrix} ]$$

In this case, the purpose of halving UE1's traffic rate by weighting two QoS levels can be implemented in a number of different ways. In one embodiment, to maintain or maximize the traffic rate for UE2, the weighting factors may be α₁=0.29, α₂=1.14 or α₁=0.14, α₂=1.57.

The following example is with QoS priorities, QoS 1's priority factor equals β₁=2, and QoS 2's priority factor equals β₂=1

$$[ \begin{matrix}{p}_{1 , 1}^{( 0 )} & {p}_{1 , 2}^{( 0 )} \\ {p}_{2 , 1}^{( 0 )} & {p}_{2 , 2}^{( 0 )}\end{matrix} ] = [ \begin{matrix}0.3 & 0.1 \\ 0.1 & 0.5\end{matrix} ]$$

In this case, the optimization object is to provide a maximum β₁\tilde{p}_{2,1}+β₂\tilde{p}_{2,2}, subjected to (\tilde{p}_{2,1}+\tilde{p}_{2,2})≦1−(\tilde{p}_{1,1}+\tilde{p}_{1,2}). The solution is α₁=0.14, α₂=1.57.

In the following example, the UEs have the same percentage distribution ratio over two QoS levels

$$[ \begin{matrix}{p}_{1 , 1}^{( 0 )} & {p}_{1 , 2}^{( 0 )} \\ {p}_{2 , 1}^{( 0 )} & {p}_{2 , 2}^{( 0 )}\end{matrix} ] = [ \begin{matrix}0.3 & 0.1 \\ 0.45 & 0.15\end{matrix} ]$$

In this case, the traffic rate of UE 2 will follows that of UE 1 to be halved. This is the worst case for this approach's application.

In implementation, these calculation results {α₁,α₂} may be quantified in accordance with the MAC CE format.

The DeNB may respond to the low-layer (for example the MAC layer) flow control indication from relay node, and hence perform a fast flow control operation. There may be a low overhead only in the UL MAC between relay node and DeNB, e.g., by a new-defined MAC CE. There may be no impact on the high-layer operations and no impact on RN-GW/UE-GW/MME.

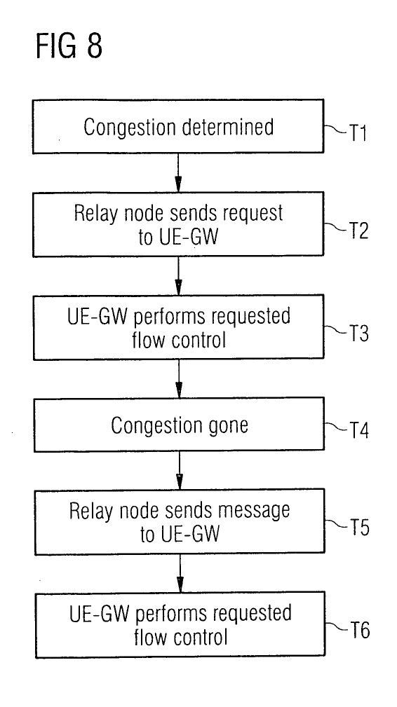

In another embodiment a per-UE bearer based flow control method, called “Per-UE bearer based flow control” is used. Reference is made to the method shown in FIG. 8. In this embodiment the operation between UE-GW and relay node in GTP-U tunnel is used. The relay node generates the flow control requirement in accordance with state of the channel of the UE and the buffer status of the UE. The relay node then indicates four kinds of request to UE-GW via a GTP-U message types: increase, decrease, start, stop. The UE-GW can then perform flow control for the UE's E-RAB bearer.

In the first step T1, congestion is determined to have occurred in the relay node.

In the case that congestion for an injured UE occurs, the relay node has options to request the corresponding element to, 1) decrease traffic rate of one, some or all bearers, and increase traffic rate later if congestion has gone; or 2) temporarily stop sending traffic on one, some or all the bearers, and start sending traffic again later if congestion has gone. Thus in step T2, the relay node sends a request to the flow control element.

For per-UE bearer based flow control, the UE-GW may be used as the flow control element of the flow control element for the first and third relay architectures whilst the eNB may be used as the flow control element for the second relay architecture. The following methods are proposed to support these two options.

The relay node can send a message to the UE-GW (step T2) and in response to the message, the UE-GW performs the requested flow control in step T3. For example the UE-GW can decrease the traffic rate of the bearer with a pre-configured step. Alternatively the message may include information as to by how much the traffic rate should be decreased or the new traffic rate. Alternatively or additionally the message may cause the UE-GW to stop sending traffic on the associate bearer.

In one embodiment, the message may comprise one special empty GTP-U packet with a specific message type (for example the vacant value of 249 in 3GPP TS29.281] (V9.0.0). Of course any unused message value can also be used) sent to UE-GW. When UE-GW receives this empty packet, the UE-GW can decrease the traffic rate of this bearer with pre-configured step. This embodiment is based on the use of a data plane GTE packet, i.e. GTP-U. In this embodiment, no additional information is put into the GTP-U packet, to avoid changing the packet format of the GTP-U packet.

However, in different embodiments of the invention, the required information may be provided inside the packet with for example, the appropriate use of one or more bits.

The relay node may alternatively or additionally be able to send one special empty GTP-U packet with specific message type (for example the vacant value of 250 in [3GPP TS29.281] (V9.0.0). Of course any unused message value can also be used) to the UE-GW. When the UE-GW receives this empty packet, the UE-GW can temporarily stop sending traffic on the associated bearer.

In step T4, it is determined that the congestion has gone.

When the congestion has gone, the relay node can send, in step T5, a message to the UE-GW which causes the UE-GW to increase the traffic rate of the bearer. The message may indicate the amount by which the traffic is to be increased, indicate a pre-configured step and/or the actually data rate. The increased data rate may not be higher than the traffic rate of the QoS profile of the bearer. Alternatively or additionally the relay node may provide a message to cause the UE-GW to start resending the traffic on the associated bearer.

In one embodiment the relay node may send one special empty GTP-U packet with a specific message type (for example the vacant value of 251 in [3GPP TS29.281] (V9.0.0). Of course any unused message value can also be used) to the UE-GW. When UE-GW receives this empty GTP-U packet, it can increase the traffic rate of this bearer with a pre-configured step.

Alternatively or additionally, the relay node can send one special empty GTP-U packet with another specific message type (for example the vacant value of 252 in [3GPP TS29.281] (V9.0.0). Of course any unused message value can also be used) to the UE-GW. When UE-GW receives this empty GTP-U packet, it can re-start sending traffic on this bearer.

In an alternative embodiment, since the DeNB is aware of the UE's bearer, the DeNB may provide flow control. When the DeNB receives the message for flow control use, the DeNB will execute flow control by itself, and may not forward the message to the UE-GW.

For alternative four of the relay architecture, the DeNB may know which bearer needs flow control based on the indication from relay node.

This embodiment may provide per bearer flow control. There may be no impact on a UE's bearer when flow control on another UE is performed. There may be no impact on the operations of DeNB. This method may save resources of Un interface and the resources of fixed backhaul between DeNB and core network. This solution may be used for relay architectures 1, 2 and 3. The embodiments of the invention may be easy to be implemented, since flow control for UE-GW may be simple to implement.

Since flow control granularity of based on per-QoS may be bigger than that of based on per UE bearer, the per-QoS method may be used to deal with urgent flow control requirements, and the per UE bearer method may be used with non-urgent flow control requirements. In some embodiments both methods may be used, which method selected at a particular time may be based on the network conditions or the like.

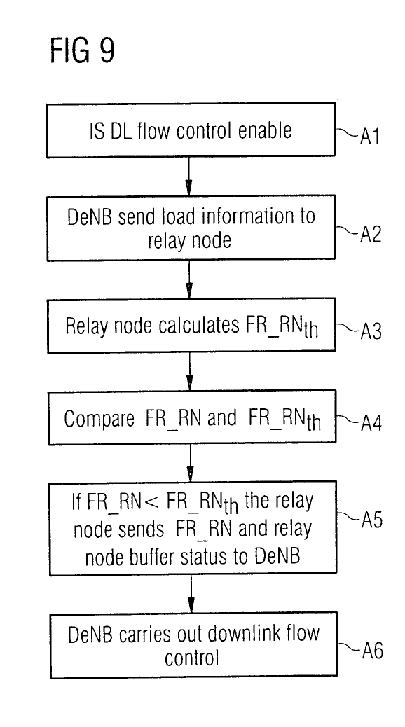

Reference is made to the method shown in FIG. 9 which relates to an access backhaul ratio and threshold.

The flow control ratio is defined for relay node as

$$FR\_RN = \frac{{TA\_RN}_{ave} ( T )}{{TR\_RN}_{ave} ( T )} ,$$

where TR_RNₐᵥₑ(T) is the average downlink throughput of relay link, and TA_RNₐᵥₑ(T) is the average downlink throughput of relay node's access link.

The relay node measures TA_RNₐᵥₑ(T) and TR_RNₐᵥₑ(T) in a period T. If FR_RN≦1 the flow control ratio is smaller and the downlink flow mismatch may be more serious.

To realize the downlink flow control, DeNB will keep FR_RN≧FR_RNₜₕᵣ, where FR_RNₜₕᵣ=fun(network_load), where the network load indicates the network load status, for example are there many active UEs connected with the DeNB, or are only a few active UEs connected with the DeNB. In embodiments of the invention, the function may be defined such when the network load is high, a relatively large FR_RN is allowed and when the network load is low, FR_RN is relative low. An example is given in the table below. An example FR_RNₜₕᵣ function is defined as following table

| FR_RNₜₕᵣ | Network load |
|---|---|
| 0.5 | Low |
| 0.75 | Medium |
| 1 | High |

The Network load information can be broadcast by the DeNB or sent to the relay node using RRC signalling by the DeNB periodically. The relay node will calculate the FR_RNₜₕᵣ according to the equation or using the above table. If the measured FR_RN is less than FR_RNₜₕᵣ, the relay node will send the measured FR_RN and the relay node buffer status to DeNB, and the DeNB will carry out the downlink flow control accordingly. Similarly, the flow control ratio can also be defined per UE.

$$FR\_UE = \frac{{TA\_UE}_{ave} ( T )}{{TR\_UE}_{ave} ( T )} ,$$

where TR_UEₐᵥₑ(T) is the average downlink throughput in a relay link for a UE, TA_UEₐᵥₑ(T) is the average downlink throughput of the UE connected with the relay node.

The DL flow control may be triggered based on the configuration information from the DeNB:

The DeNB configures the relay node to control if the DL flow control shall be applied over the backhaul link. The equation or table may be used to calculate the FR_RNₜₕᵣ or FR_UEₜₕᵣ.

It is determined that the DL flow control is enabled in step A1, the DeNB indicates to the relay node the load status of the networks such as xxx bit signalling to indicate the load is high, medium or low in step A2. The signalling can be sent through broadcast or RRC signalling.

The relay node will calculate the FR_RNₜₕₑ or FR_UEₜₕᵣ over which the relay node would trigger its DL flow control indication to DeNB in step A3. In case that DL flow control indication from relay node to DeNB is per-UE or per-relay node, different thresholds may be configured respectively per-UE or per-relay node.

In step A4 the relay node determines if the measured FR_RN is less than FR_RNₜₕᵣ. Based on the comparison if the measured value is less than the threshold, in step A5 the relay node will send the measured FR_RN and the relay node buffer status to DeNB. In step A6, the DeNB will carry out the downlink flow control accordingly.

The flow control decision may be made by the relay node or the DeNB. If the DeNB makes the decision, then the RN may advise the DeNB about its buffer status and the access link situation.

In the downlink flow control, the DeNB may reduce the traffic rate across the Un interface or stop sending the traffic with a low priority. The relay node may not know the DL buffer status of DeNB, and so the eNB may cancel the traffic reducing in Un interface automatically after a downlink flow control period P(dl_fl).

Reference is made to FIG. 7 which shows an apparatus 201 which may be used in embodiments of the invention. The apparatus 201 comprises at least one memory 200 and at least one buffer 206. The apparatus also comprises at least one data processing unit 202 and transmit/receive circuitry 208. The transmit part of the circuitry will up convert signals from the base band to the transmitting figure and may provide suitable modulation and/or encoding. The receive part of the circuitry 208 is able to down convert the received signals to the baseband and may provide suitable demodulation and/or decoding. The apparatus is has input/output interface 204 which connects the transmit/receive circuitry to an antenna 205

The transmit/receive circuitry 208 is connected to the memory 200, the data processing unit 202 and the buffer 206. The data processing unit 202 is also connected to the memory 200 and the buffer 206. The buffer 206 is also connected to the memory.

The buffer 206 comprises a plurality of buffers, as described in relation to FIG. 5.

This apparatus may be provided in the base station or the relay node. It should be appreciated that the apparatus may be provided in a gateway although the interface may be configured to make a wired connection. The antenna and transmit/receive circuitry may be omitted or modified such that the baseband/radio frequency function at least is omitted.

The required data processing unit and functions of a relay node and a base station apparatus as well as the gateways may be provided by means of one or more data processors. The above described functions may be provided by separate processors or by an integrated processor. The data processing may be distributed across several data processing modules. A data processor may be provided by means of, for example, at least one chip. Appropriate memory capacity can also be provided in the relevant nodes. An appropriately adapted computer program code product or products may be used for implementing the embodiments, when loaded on an appropriate data processing apparatus, for example in a processor apparatus associated with the base station, processing apparatus associated with relay node and/or a data processing apparatus associated with a GW.

The program code product for providing the operation may be stored on, provided and embodied by means of an appropriate carrier medium. An appropriate computer program can be embodied on a computer readable record medium. A possibility is to download the program code product via a data network.

A non-limiting example of mobile architectures where the herein described principles may be applied is known as the Evolved Universal Terrestrial Radio Access Network (E-UTRAN). The eNBs may provide E-UTRAN features such as user plane Radio Link Control/Medium Access Control/Physical layer protocol (RLC/MAC/PHY) and control plane Radio Resource Control (RRC) protocol terminations towards the user devices.

Embodiments of the invention have been described in relation to downlink control. Alternative embodiments may additionally or alternatively be used to provide uplink control.

It is noted that whilst embodiments have been described in relation to LTE, similar principles can be applied to any other communication system where relaying is employed. Therefore, although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention.

1. A method comprising:
determining traffic adjustment information for traffic from a base station to a relay node in dependence on a quantity of data intended for each user equipment at a first quality of service level on a first radio bearer; and
causing said traffic adjustment information to be sent to a network element.

2. A method as claimed in claim 1, wherein said determining is responsive to traffic congestion.

3. A method as claimed in claim 1, comprising determining traffic adjustment information for said first radio bearer between said base station and said relay node.

4. A method as claimed in claim 1, wherein said determining comprises determining traffic adjustment information in dependence on the quantity of data intended for said user equipment at a plurality of quality of service levels on a plurality of radio bearers between the base station and the relay node.

5. A method as claimed in claim 1, wherein said determining comprises determining a weight dependent on each quality of service level on a plurality of radio bearers between the base station and the relay node.

6. A method as claimed in claim 1, wherein said quality of service is indicated by a quality of service class index.

7. A method as claimed in claim 1, wherein causing said traffic adjustment information to be sent to said network element comprises providing a MAC layer message.

8. A method as claimed in claim 7, comprising causing said traffic adjustment information to be sent in a MAC control element.

9. A method as claimed in claim 7, comprising causing said traffic adjustment information to be sent in a MAC packet data unit.

10. A method as claimed in claim 1, wherein said causing said traffic adjustment information to be sent to said network element occurs periodically.

11. A method as claimed in claim 1, wherein said causing said traffic adjustment information to be sent to said network element occurs in response to a trigger.

12. A method as claimed in claim 11, wherein said trigger comprises a buffer being filled to a predetermined extent.

13. A method as claimed in claim 1, wherein said network element comprises said base station.

14. A method comprising:
receiving traffic adjustment information for at least one radio bearer from a relay node; and
using said traffic adjustment information to control the traffic rate of said at least one radio bearer between said relay node and said base station, said at least one radio bearer having an associated quality of service and configured to carry data for a plurality of user equipment.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A method comprising:
receiving in a network element, via a tunnel, traffic adjustment information for traffic from a base station to a relay node, and
using said traffic adjustment information to adjust the traffic on a bearer between said base station and said relay node associated with said tunnel.

33. A method as claimed in claim 32, wherein said network element comprises said base station and said method comprises receiving in said base station said traffic adjustment information and preventing the forwarding of at least one flow control specific packet to a gateway

34. A method as claimed in claim 32, wherein said network element comprises a gateway

35. A method as claimed in claim 32, wherein said traffic adjustment information comprises one of:
decrease traffic rate; increase traffic rate; stop sending traffic and start sending traffic.

36. A method as claimed in claim 32, wherein said traffic adjustment information is provided in a GTP packet.

37. A method as claimed in claim 36, wherein said traffic adjustment information is provided with an empty GTP packet.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)
